(19) United States
(12) Patent Application Publication
(10) Pub. No.: US 2024/0247956 A1
(43) Pub. Date: Jul. 25, 2024

(54) MAGNETIC DETECTION DEVICE

(71) Applicant: Mitsubishi Electric Corporation, Tokyo (JP)

(72) Inventors: Muneki NAKADA, Chiyoda-ku, Tokyo (JP); Hideki SHIMAUCHI, Chiyoda-ku, Tokyo (JP); Kaito TAKESHIMA, Chiyoda-ku, Tokyo (JP)

(73) Assignee: Mitsubishi Electric Corporation, Tokyo (JP)

(21) Appl. No.: 18/566,095

(22) PCT Filed: Jun. 10, 2021
(86) PCT No.: PCT/JP2021/022116

§ 371 Date: Dec. 1, 2023

(51) Int. Cl. G01D 5/245

(52) U.S. Cl. CPC G01D 5/245

(57) ABSTRACT

A magnetic detection device includes a magnet portion, a plurality of magneto-electric conversion elements, and a magnetic plate. Plurality of magneto-electric conversion elements are overlaid on magnet portion along a magnetization direction of magnet portion. Magnetic plate is overlaid on plurality of magneto-electric conversion elements along the magnetization direction. A magnetism sensing direction of plurality of magneto-electric conversion elements intersects with the magnetization direction. Magnetic plate has a longitudinal direction that intersects with the magnetization direction.

### TECHNICAL FIELD

The present disclosure relates to a magnetic detection device.

### BACKGROUND ART

A magnetic detection device having a plurality of magneto-electric conversion elements is known. The plurality of magneto-electric conversion elements constitute a bridge circuit. In end parts of each of the plurality of magneto-electric conversion elements, electrodes are provided. Between two opposite electrodes of the bridge circuit, a power source is connected. The power source is configured to output a voltage of constant voltage, and a current of constant current. The magnetic detection device is configured to detect change in the magnetic field acting on the magneto-electric conversion element by converting change in resistance of the plurality of magneto-electric conversion elements into change in voltage.

For example, the magnetic detection device (rotation detection device) described in Japanese Patent Laying-Open No. 2005-156368 (PTL 1) includes a magnet portion (magnet), a plurality of magneto-electric conversion elements, and a substrate. The plurality of magneto-electric conversion elements are arranged on the substrate. The magnetic detection device is a device for sensing a rotation direction of a moving magnetic body by detecting change in the magnetic field intensity due to rotation of the moving magnetic body by the magneto-electric conversion elements.

The magnetic field intensity changes as a protruding portion of the moving magnetic body approaches the magneto-electric conversion elements.

### CITATION LIST

### Patent Literature

PTL 1: Japanese Patent Laying-Open No. 2005-156368

### SUMMARY OF INVENTION

### Technical Problem

In the magnetic detection device described in the above publication, the magnetic field generated from the magnet portion has the position dependence. That is, the direction of the magnetic field applied to the first magneto-electric conversion element arranged on an end part side of the magnet portion is different from the direction of the magnetic field applied to the second magneto-electric conversion element arranged on the center side of the magnet portion. The orientation of the magnetic field applied to the first magneto-electric conversion element and the second magneto-electric conversion element changes to a diagonal direction toward the protruding portion as the protruding portion of the moving magnetic body approaches the second magneto-electric conversion element side from the first magnetic body element side. The magnetic field applied to the first magneto-electric conversion element is directed diagonally compared with the magnetic field applied to the second magneto-electric conversion element. The angular difference between the direction of the magnetic field applied to the first magneto-electric conversion element and the direction of the protruding portion viewed from the first magneto-electric conversion element is smaller than the angular difference between the direction of the magnetic field applied to the second magneto-electric conversion element and the direction of the protruding portion viewed from the second magneto-electric conversion element. Therefore, change in the magnetic field intensity in the first magneto-electric conversion element is smaller than change in the magnetic field intensity in the second magneto-electric conversion element. Therefore, the sensitivity of the magnetic detection device is low.

The present disclosure was made in light of the above problems, and it is an object of the present disclosure to provide a magnetic detection device capable of improving the detection sensitivity.

### Solution to Problem

The magnetic detection device of the present disclosure includes a magnet portion, a plurality of magneto-electric conversion elements, and a magnetic plate. The plurality of magneto-electric conversion elements are overlaid on the magnet portion along the magnetization direction of the magnet portion. The magnetic plate is overlaid on the plurality of magneto-electric conversion elements along the magnetization direction. A magnetism sensing direction of the plurality of magneto-electric conversion elements intersects with the magnetization direction. The magnetic plate has a longitudinal direction that intersects with the magnetization direction.

### Advantageous Effects of Invention

According to the magnetic detection device of the present disclosure, it is possible to improve the detection sensitivity of the magnetic detection device.

### BRIEF DESCRIPTION OF DRAWINGS

FIG. 1 is a perspective view schematically showing a configuration of a magnetic detection device according to Embodiment 1.

FIG. 2 is a top view schematically showing a configuration of the magnetic detection device according to Embodiment 1.

FIG. 3 is a circuit view schematically showing a configuration of the magnetic detection device according to Embodiment 1.

FIG. 4 is a top view schematically showing a magnetic field applied to the magnetic detection device according to Embodiment 1.

FIG. 5 is a top view schematically showing a configuration of a magnetic detection device according to a comparative example, and a magnetic field applied to the magnetic detection device according to the comparative example.

FIG. 6 is a top view schematically showing a configuration of a magnetic detection device according to Embodiment 2.

FIG. 7 is a top view schematically showing a configuration of a magnetic detection device according to Embodiment 3.

FIG. 8 is a top view schematically showing a configuration of the magnetic detection device according to Embodiment 4.

FIG. 9 is a top view schematically showing a configuration of a magnetic detection device according to a modified example of Embodiment 4.

FIG. 10 is a top view schematically showing a configuration of a magnetic detection device according to Embodiment 5.

FIG. 11 is a top view schematically showing a configuration of a magnetic detection device according to Embodiment 6.

FIG. 12 is a top view schematically showing a magnetic field applied to the magnetic detection device according to Embodiment 6.

FIG. 13 is a top view schematically showing a configuration of a magnetic detection device according to Embodiment 7.

### DESCRIPTION OF EMBODIMENTS

Hereinafter, embodiments are described with reference to the drawings. In the following, the same or the corresponding part is denoted by the same reference numeral and overlapping description is not repeated.

### Embodiment 1

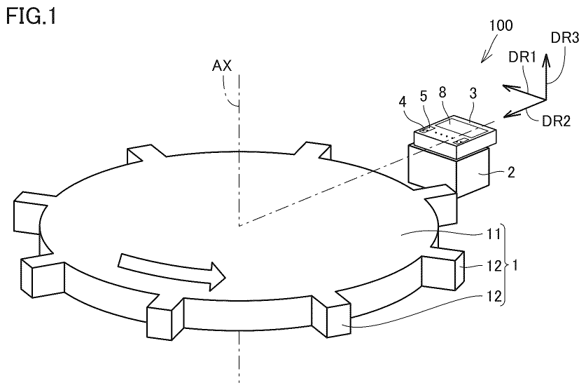

Referring to FIGS. 1 to 4, a configuration of a magnetic detection device 100 according to Embodiment 1 is described.

As shown in FIG. 1, magnetic detection device 100 is configured to detect change in the magnetic field due to movement of a moving magnetic body 1. Magnetic detection device 100 is configured, for example, to detect change in the magnetic field due to rotation of moving magnetic body 1. Magnetic detection device 100 of the present embodiment is used, for example, to detect rotation of a crank or a cam or the like for control of an engine of an automobile. Moving magnetic body 1 is attached, for example, to a shaft of an engine. By rotation of the shaft, moving magnetic body 1 rotates. In FIG. 1 to FIG. 4, the rotation direction of moving magnetic body 1 is indicated by an open arrow. The principle of detecting change in the magnetic field by moving magnetic body 1 by magnetic detection device 100 of the present embodiment is described later.

Moving magnetic body 1 includes a disc portion 11, and a plurality of protruding portions 12. Disc portion 11 is configured to rotate. Each of plurality of protruding portions 12 protrudes from disc portion 11 along the radial direction of disc portion 11. Moving magnetic body 1 is configured to change the surrounding magnetic field by rotation of disc portion 11. A rotation axis AX of moving magnetic body 1 passes through the center of disc portion 11. Rotation axis AX of moving magnetic body 1 extends along a later-described Z axial direction DR3.

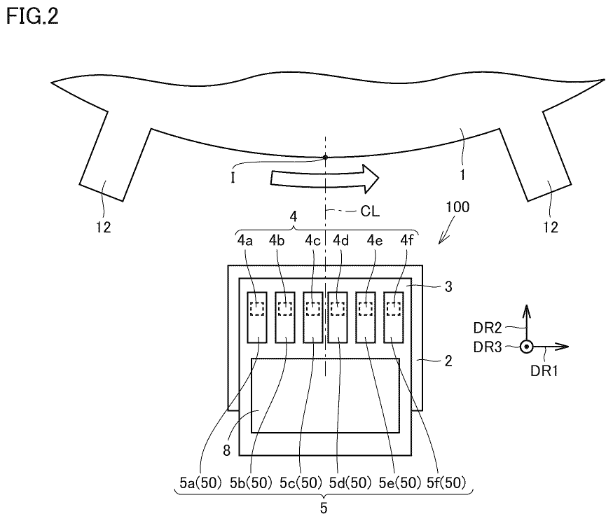

As shown in FIG. 2, magnetic detection device 100 includes a magnet portion 2, a substrate 3, a plurality of magneto-electric conversion elements 4, and a magnetic plate 5. In FIG. 2, contours of plurality of magneto-electric conversion elements 4 arranged between substrate 3 and magnetic plate 5 are indicated by the broken lines. In the present embodiment, the direction in which plurality of magneto-electric conversion elements 4 are arranged is an X axial direction DR1. The direction toward moving magnetic body 1 from magnetic detection device 100 is a Y axial direction DR2. The direction in which magnetic plate 5 is overlaid on plurality of magneto-electric conversion elements 4 is a Z axial direction DR3. X axial direction DR1, Y axial direction DR2 and Z axial direction DR3 are orthogonal to one another. X axial direction DR1 is also a moving direction of moving magnetic body 1 at a position of magnetic detection device 100. X axial direction DR1 is also a normal direction of disc portion 11 at an intersection I between disc portion 11 and Y axis.

Magnet portion 2 is, for example, a permanent magnet. Magnet portion 2 may be, for example, an electromagnet. Magnet portion 2 has a magnetization direction. The magnetization direction of magnet portion 2 is a direction of magnetization of magnet portion 2. The magnetization direction runs along Z axial direction DR3. It is desired that plurality of magneto-electric conversion elements 4 are arranged symmetrically with respect to a center line CL in X axial direction DR1 of magnet portion 2. It is desired that plurality of magneto-electric conversion elements 4 are arranged deviating from the center line in Y axial direction DR2 of magnet portion 2.

The magnetic field by magnet portion 2 exits the N pole of magnet portion 2 and goes toward the S pole that is opposite to the N pole. In the course of going from the N pole toward the S pole, the magnetic field bends along at least either of X axial direction DR1 and Y axial direction DR2. X axial direction DR1 component of magnetic field increases with the distance from center line CL. On center line CL in X axial direction DR1 of magnet portion 2, the magnetic field does not have X axial direction DR1 component. At a position deviated from the center line in Y axial direction DR2 of magnet portion 2, the magnetic field has Y axial direction DR2 component.

Substrate 3 has width along X axial direction DR1. Substrate 3 has end parts and the center in X axial direction DR1. Plurality of magneto-electric conversion elements 4 are arranged in both ends and the center of substrate 3. To magneto-electric conversion elements 4 (first magneto-electric conversion element 4a and sixth magneto-electric conversion element 4f) arranged in end parts of substrate 3, magnetic field components of X axial direction DR1 and Y axial direction DR2 are applied. The magnetic field along X axial direction DR1 that is applied to magneto-electric conversion elements 4 arranged in the center of substrate 3 (third magneto-electric conversion element 4c and fourth magneto-electric conversion element 4d) is smaller than the magnetic field along X axial direction DR1 that is applied to magneto-electric conversion elements 4 arranged in end parts of substrate 3.

Substrate 3 is overlaid on magnet portion 2 along the magnetization direction (Z axial direction DR3). It is desired that the center line in X axial direction DR1 of substrate 3 coincides with center line CL in X axial direction DR1 of magnet portion 2. On substrate 3, plurality of magneto-electric conversion elements 4 and magnetic plate 5 are mounted. Substrate 3, plurality of magneto-electric conversion elements 4 and magnetic plate 5 may be integrally configured. Substrate 3 is, for example, a printed board. Substrate 3 may be a silicon (Si) substrate. Substrate 3, plurality of magneto-electric conversion elements 4 and magnetic plate 5 may be integrally configured by a semiconductor process. Substrate 3, plurality of magneto-electric conversion elements 4 and magnetic plate 5 may be separate from each other.

Substrate 3 has a signal processing circuit 8. Signal processing circuit 8 is configured to sense movement of moving magnetic body 1 according to an electric signal transmitted from plurality of magneto-electric conversion elements 4. Signal processing circuit 8 is configured, for example, by an integrated circuit (IC).

Plurality of magneto-electric conversion elements 4 are overlaid on the magnet portion 2 along the magnetization direction of the magnet portion 2. Plurality of magneto-electric conversion elements 4 is overlaid on magnet portion 2 along Z axial direction DR3. Each of plurality of magneto-electric conversion elements 4 is configured to convert change in the magnetic field into change in electric signal. Each of plurality of magneto-electric conversion elements 4 is configured to transmit an electric signal to signal processing circuit 8 of substrate 3.

Each of plurality of magneto-electric conversion elements 4 is a magneto resistive (MR) element or a magneto impedance (MI) element. When each of plurality of magneto-electric conversion elements 4 is a magneto resistive element, it is desired that each of plurality of magneto-electric conversion elements 4 is either of a giant magneto resistive element (GMR element) and a tunnel magneto resistive element (TMR element). Magneto-electric conversion element 4 is configured to detect change in the magnetic field in a virtual plane formed by X axial direction DR1 and Y axial direction DR2.

Plurality of magneto-electric conversion elements 4 have a magnetism sensing direction. Magneto-electric conversion element 4 is configured to detect change in the magnetic field along the magnetism sensing direction. Magnetism sensing directions of plurality of magneto-electric conversion elements 4 intersect with the magnetization direction (Z axial direction DR3). In the present embodiment, the magnetism sensing direction of each of plurality of magneto-electric conversion elements 4 is orthogonal to the magnetization direction of magnet portion 2 (Z axial direction DR3). The magnetism sensing direction of each of plurality of magneto-electric conversion elements 4 is orthogonal to the moving direction of moving magnetic body 1.

In the present embodiment, the magnetism sensing direction of each of plurality of magneto-electric conversion elements 4 runs along Y axial direction DR2. Therefore, each of plurality of magneto-electric conversion elements 4 is configured to detect change in the magnetic field along Y axial direction DR2. As will be described later, the magnetism sensing direction may run along X axial direction DR1.

Plurality of magneto-electric conversion elements 4 are arranged at an interval from each other. Plurality of magneto-electric conversion elements 4 may be arranged at regular intervals. Plurality of magneto-electric conversion elements 4 are arranged at intervals so as to intersect with the magnetization direction. Plurality of magneto-electric conversion elements 4 are arranged at intervals along X axial direction DR1.

In the present embodiment, plurality of magneto-electric conversion elements 4 include a first magneto-electric conversion element 4a to a sixth magneto-electric conversion element 4f. First magneto-electric conversion element 4a to sixth magneto-electric conversion element 4f are arranged at an interval from each other. First magneto-electric conversion element 4a to sixth magneto-electric conversion element 4f are arranged in line in this order along X axial direction DR1. First magneto-electric conversion element 4a to third magneto-electric conversion element 4c are arranged on the opposite side of fourth magneto-electric conversion element 4d to sixth magneto-electric conversion element 4f with respect to center line CL in X axial direction DR1 of magnet portion 2.

First magneto-electric conversion element 4a and sixth magneto-electric conversion element 4f are arranged symmetrically with respect to center line CL in X axial direction DR1 of magnet portion 2. Second magneto-electric conversion element 4b and fifth magneto-electric conversion element 4e are arranged symmetrically with respect to center line CL in X axial direction DR1 of magnet portion 2. Third magneto-electric conversion element 4c and fourth magneto-electric conversion element 4d are arranged symmetrically with respect to center line CL in X axial direction DR1 of magnet portion 2. The number of magneto-electric conversion elements 4 is not limited to six.

As will be described later, one pair of magneto-electric conversion elements 4 constitute one bridge circuit. First magneto-electric conversion element 4a to sixth magneto-electric conversion element 4f constitute three bridge circuits.

First magneto-electric conversion element 4a to sixth magneto-electric conversion element 4f may be formed integrally with substrate 3 by deposition on signal processing circuit 8 of substrate 3 made of silicon (Si). On first magneto-electric conversion element 4a to sixth magneto-electric conversion element 4f, an unillustrated insulating film may be arranged. Magnetic plate 5 may be deposited on the unillustrated insulating film. In this case, substrate 3, magneto-electric conversion element 4, the unillustrated insulating film and magnetic plate 5 are integrally formed. Magnetic plate 5 is deposited, for example, by lamination of a magnetic body by a semiconductor process. The magnetic body is deposited, for example, by a CVD (Chemical Vapor Deposition) method, sputtering, vapor deposition or plating or the like. The magnetic body is formed into the shape of magnetic plate 5 through the steps of photolithography and etching.

Magnetic plate 5 is overlaid on plurality of magneto-electric conversion elements 4 along the magnetization direction. Magnetic plate 5 is overlaid on plurality of magneto-electric conversion elements 4 along Z axial direction DR3. In FIG. 2, magnetic plate 5 and magnet portion 2 sandwich plurality of magneto-electric conversion elements 4. That is, magnetic plate 5, plurality of magneto-electric conversion elements 4 and magnet portion 2 may be arranged in this order along Z axial direction DR3. Although not illustrated, magnetic plate 5 may be arranged between magnet portion 2 and plurality of magneto-electric conversion elements 4.

Magnetic plate 5 has a longitudinal direction that intersects with the magnetization direction. The longitudinal direction of magnetic plate 5 intersects with Z axial direction DR3. It is desired that the longitudinal direction of magnetic plate 5 is orthogonal to Z axial direction DR3.

It is desired that the longitudinal direction of magnetic plate 5 runs along the magnetism sensing direction of plurality of magneto-electric conversion elements 4. The longitudinal direction of magnetic plate 5 runs along Y axial direction DR2. As will be described later, the longitudinal direction of magnetic plate 5 may run along X axial direction DR1. The longitudinal direction of magnetic plate 5 is only required to be present in a virtual plane formed by X axial direction DR1 and Y axial direction DR2. It is desired that the longitudinal direction of magnetic plate 5 is orthogonal to the moving direction of moving magnetic body 1.

Magnetic plate 5 has a short direction that is orthogonal to the longitudinal direction. The dimension in the longitudinal direction of magnetic plate 5 is larger than the dimension in the short direction of magnetic plate 5. The short direction of magnetic plate 5 runs along X axial direction DR1.

In the present embodiment, an aspect ratio of magnetic plate 5 means a ratio of the longitudinal direction of magnetic plate 5 to the short direction of magnetic plate 5. The aspect ratio of magnetic plate 5 is larger than 1. The aspect ratio magnetic plate 5 is, for example, greater than or equal to 2.

Magnetic plate 5 includes a plurality of magnetic body portions 50. Each of plurality of magnetic body portions 50 is overlaid on a corresponding one of plurality of magneto-electric conversion elements 4. The dimension in the longitudinal direction of each of plurality of magnetic body portions 50 is larger than the dimension in the longitudinal direction of plurality of magneto-electric conversion elements 4. The dimension in the short direction of each of plurality of magnetic body portions 50 is equal to or more than the dimension in the short direction of each of plurality of magneto-electric conversion elements 4.

In the present embodiment, plurality of magnetic body portions 50 includes a first magnetic body portion 5a to a sixth magnetic body portion 5f. Each of first magnetic body portion 5a to sixth magnetic body portion 5f is overlaid on a corresponding one of first magneto-electric conversion element 4a to sixth magneto-electric conversion element 4f. The number of magnetic body portions 50 is not limited to six, and may be appropriately determined.

First magnetic body portion 5a to sixth magnetic body portion 5f are arranged in this order along X axial direction DR1. Third magnetic body portion 5c and fourth magnetic body portion 5d are arranged to sandwich the center line in X axial direction DR1 of magnet portion 2. Second magnetic body portion 5b and fifth magnetic body portion 5e are arranged to sandwich third magnetic body portion 5c and fourth magnetic body portion 5d along X axial direction DR1. First magnetic body portion 5a and sixth magnetic body portion 5f are arranged to sandwich second magnetic body portion 5b to fifth magnetic body portion 5e along X axial direction DR1.

The shape of magnetic plate 5 when magnetic plate 5 is viewed along the magnetization direction is a polygon. Specifically, the shape of magnetic plate 5 when magnetic plate 5 is viewed along the magnetization direction is a rectangle. As will be described later, the shape of magnetic plate 5 may be other shape than a rectangle.

Magnetic plate 5 is configured by a magnetic body. The material for magnetic plate 5 is, for example, magnetic steel sheet, iron (Fe), permalloy or ferrite. The material for magnetic plate 5 may be, for example, a ferromagnetic material containing at least either one of iron (Fe), cobalt (Co) and nickel (Ni). The material for magnetic plate 5 may be a soft magnetic material having high magnetic permeability. For example, permalloy, which is an alloy of iron (Fe) and nickel (Ni), is a soft magnetic material having high magnetic permeability, and hence is suitable for a material for magnetic plate 5.

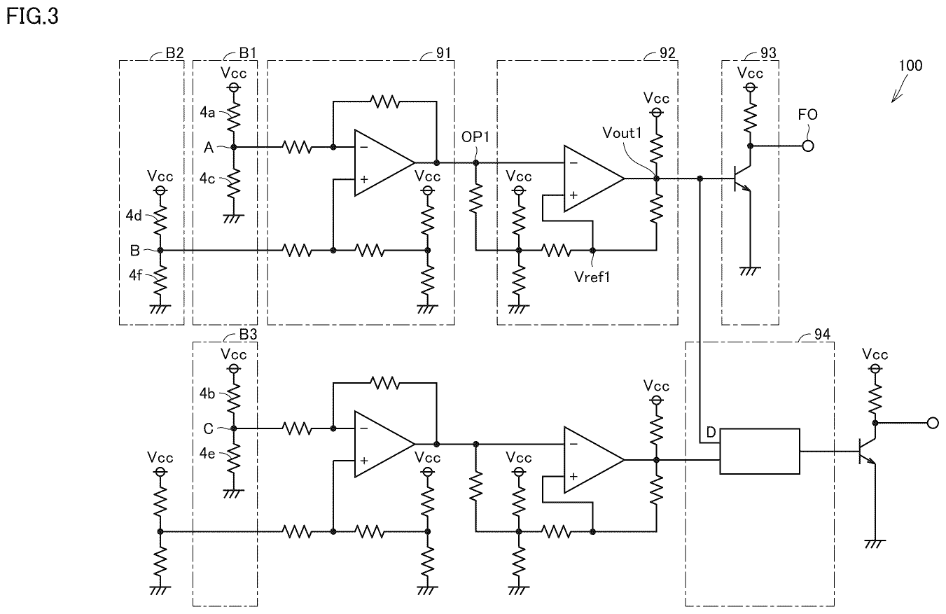

As shown in FIG. 3, first magneto-electric conversion element 4a and third magneto-electric conversion element 4c constitute a first bridge circuit B1. Vcc in FIG. 3 indicates constant voltage. Constant voltage Vcc is applied to first bridge circuit B1. Change in resistances of first magneto-electric conversion element 4a and third magneto-electric conversion element 4c due to change in the magnetic field is detected as change in voltage. That is, change in the magnetic field is converted into change in voltage.

Fourth magneto-electric conversion element 4d and sixth magneto-electric conversion element 4f constitute a second bridge circuit B2. Constant voltage Vcc is applied to second bridge circuit B2. Change in resistances of fourth magneto-electric conversion element 4d and sixth magneto-electric conversion element 4f due to change in the magnetic field is detected as change in voltage.

Second magneto-electric conversion element 4b and fifth magneto-electric conversion element 4e constitute a third bridge circuit B3. Constant voltage Vcc is applied to third bridge circuit B3. Change in resistances of second magneto-electric conversion element 4b and fifth magneto-electric conversion element 4e due to change in the magnetic field is detected as change in voltage.

A first mid-point output A after voltage conversion by first bridge circuit B1 is amplified as a differential output OP1 by an amplification circuit 91. A second mid-point output B after voltage conversion by second bridge circuit is amplified as differential output OP1 by amplification circuit 91. Differential output OP1 is input into a comparison circuit 92. Differential output OP1 is compared with a voltage Vref1 for comparison in comparison circuit 92. Comparison circuit 92 outputs a first signal and a second signal. The first signal is converted into a final output FO by an output circuit 93. A rotation angle of a magnetic moving body is detected by final output FO. The second signal is input into a D terminal D of a D flip-flop circuit 94.

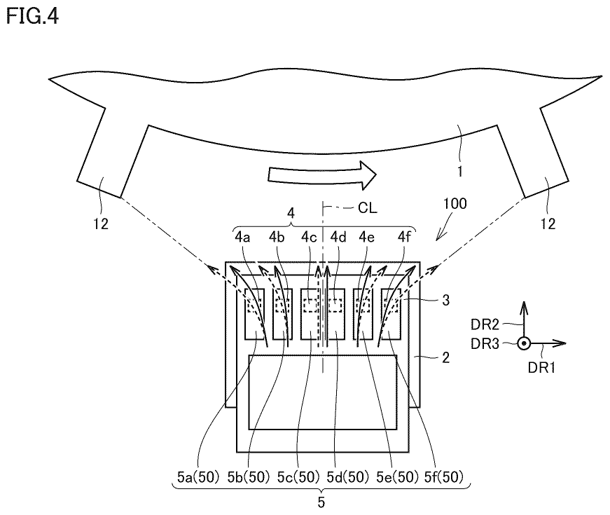

Next, referring to FIG. 4, the principle of detecting magnetic field by magnetic detection device 100 according to Embodiment 1 is described.

In FIG. 4, a direction of magnetic field applied to each of plurality of magneto-electric conversion elements 4, and a line connecting magneto-electric conversion element 4 (first magneto-electric conversion element 4a and sixth magneto-electric conversion element 4f) and protruding portion 12 are illustrated. In FIG. 4, the direction of the magnetic field applied to each of plurality of magneto-electric conversion elements 4 is indicated by a solid line. In FIG. 4, the line connecting magneto-electric conversion element 4 (first magneto-electric conversion element 4a and sixth magneto-electric conversion element 4f) and protruding portion 12 is indicated by a two-dot chain line. The broken line indicates the orientation of the magnetic field when magnetic detection device 100 does not include magnetic plate 5.

The magnetic field is applied to each of plurality of magneto-electric conversion elements 4. In the present embodiment, magneto-electric conversion element 4 detects change in the magnetic field along the magnetism sensing direction (Y axial direction DR2) when protruding portion 12 approaches or goes away from magneto-electric conversion element 4.

As protruding portion 12 of moving magnetic body 1 approaches magneto-electric conversion element 4 along X axial direction DR1, the angle formed by the orientation of the magnetic field applied to magneto-electric conversion element 4 and Y axial direction DR2 decreases. Thus, Y axial direction DR2 component of magnetic field applied to magneto-electric conversion element 4 increases. As protruding portion 12 of moving magnetic body 1 goes away from magneto-electric conversion element 4 along X axial direction DR1, the angle formed by the orientation of the magnetic field applied to magneto-electric conversion element 4 and Y axial direction DR2 increases. Thus, Y axial component of magnetic field applied to magneto-electric conversion element 4 decreases. Magneto-electric conversion element 4 detects change in the magnetic field according to the change in Y axial direction DR2 component of the magnetic field.

Next, the operation and effect of magnetic detection device 100 according to the present embodiment is described by comparison with a magnetic detection device 101 according to a comparative example.

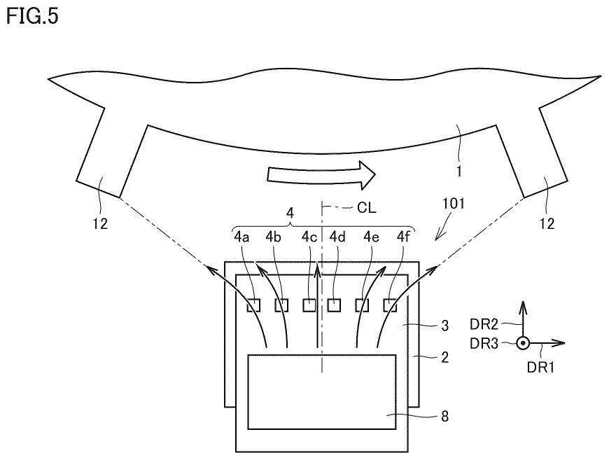

As shown in FIG. 5, magnetic detection device 101 according to the comparative example does not include magnetic plate 5 (see FIG. 1). Magnetic detection device 101 according to the comparative example has the same configuration as magnetic detection device 100 according to the present embodiment except that it does not include magnetic plate 5 (see FIG. 1). The magnetism sensing direction of magnetic detection device 101 according to the comparative example is Y axial direction.

In magnetic detection device 101 according to the comparative example, when protruding portion 12 is arranged at a position apart from first magneto-electric conversion element 4a, there is an angular difference between the direction of the magnetic field applied to first magneto-electric conversion element 4a and the direction of the line connecting first magneto-electric conversion element 4a and protruding portion 12. The angular difference is smaller than the angular difference in the case where magnetic plate 5 is provided (see FIG. 4). The magnetic field changes to be drawn in by approach of protruding portion 12. However, since the angular difference is smaller than that in the case where magnetic plate 5 is provided (see FIG. 4), change in the magnetic field applied to first magneto-electric conversion element 4a when protruding portion 12 moves to approach first magneto-electric conversion element 4a is also smaller than that in the case where magnetic plate 5 is provided (see FIG. 4). Therefore, change in Y axial direction DR2 component of the magnetic field applied to magneto-electric conversion element 4 is also smaller than that in the case where magnetic plate 5 is provided (see FIG. 4). Therefore, also change in the magnetic field sensed by magneto-electric conversion element 4 is smaller than that in the case where magnetic plate 5 is provided (see FIG. 4). Therefore, the detection sensitivity of magnetic detection device 101 according to the comparative example is lower than that in the case where magnetic plate 5 is provided (see FIG. 4).

In contrast to this, according to magnetic detection device 100 according to the present embodiment, as shown in FIG. 2, magnetic plate 5 has a longitudinal direction that intersects with the magnetization direction. Therefore, it is possible to correct the magnetic field so that the magnetic field applied to each of plurality of magneto-electric conversion elements 4 runs along the longitudinal direction of magnetic plate 5. Therefore, change in the magnetic field when moving magnetic body 1 approaches magneto-electric conversion element 4 can be increased compared with the case where magnetic plate 5 is not provided (see FIG. 5). Therefore, it is possible to improve the detection sensitivity of magnetic detection device 100.

More specifically, magnetic plate 5 has a longitudinal direction that intersects with the magnetization direction. Therefore, it is possible to correct the magnetic field generated from magnet portion 2 to run along the longitudinal direction of magnetic plate 5. Since the longitudinal direction of magnetic plate 5 runs along Y axial direction DR2, the magnetic field generated from magnet portion 2 can be corrected to run along Y axial direction DR2. That is, it is possible to reduce the magnetic field component of X axial direction DR1 of magnetic field. Thus, it is possible to increase the angular difference between the direction of the magnetic field applied to first magneto-electric conversion element 4a and the direction connecting first magneto-electric conversion element 4a and protruding portion 12 when protruding portion 12 is arranged at a position apart from first magneto-electric conversion element 4a. Therefore, it is possible to increase change in angle of the magnetic field applied to first magneto-electric conversion element 4a when protruding portion 12 moves to approach first magneto-electric conversion element 4a. Therefore, it is also possible to increase change in the magnetic field sensed by magneto-electric conversion element 4. Therefore, it is possible to improve the detection sensitivity of magnetic detection device 100.

Sensitivity of magneto-electric conversion element 4 can deteriorate when a magnetic field of the direction (X axial direction DR1) orthogonal to the magnetism sensing direction (Y axial direction DR2) is applied. In particular, in magnetic detection device 101 according to the comparative example, X axial direction DR1 component of the magnetic field in magneto-electric conversion elements 4 arranged in end parts of substrate 3 (first magneto-electric conversion element 4a and sixth magneto-electric conversion element 4f) is larger than that in magneto-electric conversion elements 4 arranged in the center of substrate 3. Therefore, the detection sensitivity of magneto-electric conversion elements 4 arranged in end parts of substrate 3 is lower than that of magneto-electric conversion elements 4 arranged in the center of substrate 3.

Contrarily, in magnetic detection device 100 according to the present embodiment, as shown in FIG. 2, the longitudinal direction of magnetic plate 5 runs along the magnetism sensing direction of plurality of magneto-electric conversion elements 4 (Y axial direction DR2). Therefore, it is possible to reduce X axial direction DR1 component of the magnetic field in magneto-electric conversion elements 4 arranged in end parts of substrate 3 (first magneto-electric conversion element 4a and sixth magneto-electric conversion element 4f). Therefore, it is possible to suppress deterioration in detection sensitivity of magneto-electric conversion elements 4 arranged in end parts of substrate 3.

The larger the aspect ratio of magnetic plate 5, the greater the effect of decreasing X axial direction DR1 component of the magnetic field by magnetic plate 5 can be made. Therefore, the larger the aspect ratio of magnetic plate 5, the more it is desired. For example, the aspect ratio of magnetic plate 5 is, for example, greater than or equal to 2.

As shown in FIG. 2, each of plurality of magnetic body portions 50 is overlaid on a corresponding one of plurality of magneto-electric conversion elements 4. Therefore, it is possible to correct the orientation of the magnetic field of each of plurality of magneto-electric conversion elements 4 to run along the longitudinal direction of magnetic body portion 50. Therefore, it is possible to improve the sensitivity of each of plurality of magneto-electric conversion elements 4.

As shown in FIG. 2, the shape of magnetic plate 5 in the magnetization direction is a polygon. Therefore, a magnetic body having a polygonal shape can be used as magnetic plate 5.

As shown in FIG. 2, the shape of magnetic plate 5 in the magnetization direction is a rectangle. Therefore, a magnetic body having a rectangular shape can be used as magnetic plate 5.

It is desired that each of plurality of magneto-electric conversion elements 4 is an MR element or an MI element. Thus, it is possible to improve the sensitivity of magneto-electric conversion element 4 by the in-plane magnetic detection element.

Each of plurality of magneto-electric conversion elements 4 may be either of a GMR element and a TMR element. In this case, it is possible to improve the sensitivity of magneto-electric conversion element 4 compared with the case where magneto-electric conversion element 4 is not a GMR element and a TMR element.

As shown in FIG. 1, the longitudinal direction of magnetic plate 5 may be orthogonal to the moving direction of moving magnetic body 1. In this case, it is possible to increase change in the magnetic field due to approach of moving magnetic body 1. Therefore, it is possible to improve the detection sensitivity of magnetic detection device 100.

### Embodiment 2

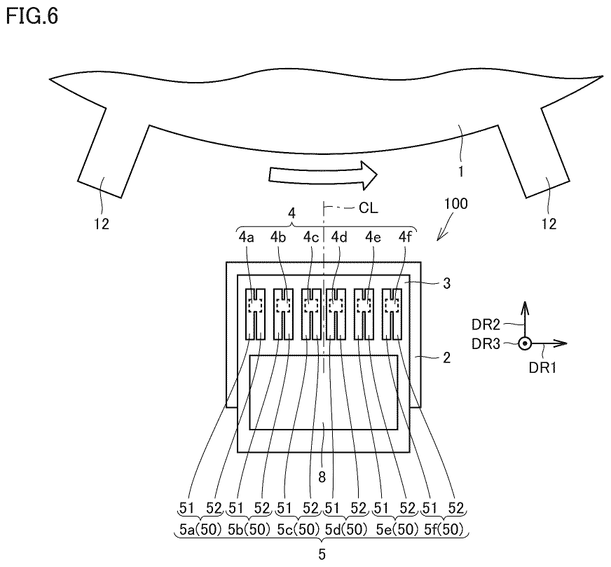

Next, referring to FIG. 6, a configuration of magnetic detection device 100 according to Embodiment 2 is described. Embodiment 2 has the same configuration and operation and effect as Embodiment 1 unless otherwise described. Therefore, the same configuration as that in Embodiment 1 is denoted by the same reference numeral, and description thereof is not repeated.

As shown in FIG. 6, magnetic plate 5 of magnetic detection device 100 according to the present embodiment includes plurality of magnetic body portions 50. Each of plurality of magnetic body portions 50 is overlaid on a corresponding one of plurality of magneto-electric conversion elements 4.

Each of plurality of magnetic body portions 50 is divided into a first magnetic body part 51, and a second magnetic body part 52 along the short direction. On each of plurality of magneto-electric conversion elements 4, first magnetic body part 51 and second magnetic body part 52 are overlaid. Each of plurality of magnetic body portions 50 may be divided into greater than or equal to three magnetic body parts.

First magnetic body part 51 and second magnetic body part 52 are arranged with a clearance therebetween. Therefore, the magneto-electric conversion element 4 has a part that is not coved with magnetic plate 5. The smaller the area of the part that is not covered with magnetic plate 5 in magneto-electric conversion element 4 the more it is preferred.

Subsequently, operation and effect of the present embodiment is described.

According to magnetic detection device 100 according to the present embodiment, as shown in FIG. 6, each of plurality of magnetic body portions 50 is divided into first magnetic body part 51 and second magnetic body part 52 along the short direction. Therefore, it is possible to improve the aspect ratio of magnetic plate 5 compared with the case where each of plurality of magnetic plates 5 is not divided. Accordingly, it is possible to further correct the magnetic field generated from magnet portion 2 to run along the longitudinal direction (Y axial direction DR2). Therefore, it is possible to further improve the sensitivity of magnetic detection device 100 for approach of protruding portion 12.

### Embodiment 3

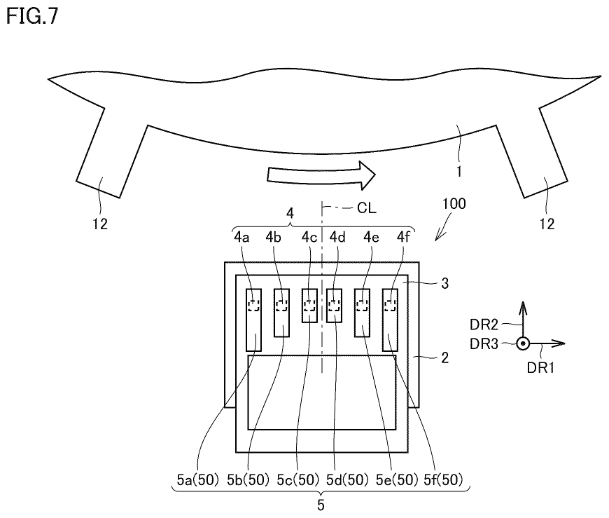

Next, referring to FIG. 7, a configuration of magnetic detection device 100 according to Embodiment 3 is described. Embodiment 3 has the same configuration and operation and effect as Embodiment 1 unless otherwise described. Therefore, the same configuration as that in Embodiment 1 is denoted by the same reference numeral, and description thereof is not repeated.

As shown in FIG. 7, plurality of magnetic body portions 50 of magnetic detection device 100 according to the present embodiment include first magnetic body portion 5a, second magnetic body portion 5b, third magnetic body portion 5c, fourth magnetic body portion 5d, fifth magnetic body portion 5e, and sixth magnetic body portion 5f.

First magnetic body portion 5a has a larger dimension along the longitudinal direction than each of second magnetic body portion 5b, third magnetic body portion 5c, fourth magnetic body portion 5d, and fifth magnetic body portion 5e. Second magnetic body portion 5b has a larger dimension along the longitudinal direction than each of third magnetic body portion 5c and fourth magnetic body portion 5d. First magnetic body portion 5a and sixth magnetic body portion 5f have the same dimension along the longitudinal direction. Second magnetic body portion 5b and fifth magnetic body portion 5e have the same dimension along the longitudinal direction. Third magnetic body portion 5c and fourth magnetic body portion 5d have the same dimension along the longitudinal direction.

Aspect ratios of first magnetic body portion 5a and sixth magnetic body portion 5f are larger than aspect ratios of second magnetic body portion 5b to fifth magnetic body portion 5e. Aspect ratios of second magnetic body portion 5b and fifth magnetic body portion 5e are larger than aspect ratios of third magnetic body portion 5c and fourth magnetic body portion 5d. Therefore, the effect of correcting the magnetic field to run along the longitudinal direction decreases in the order of first magnetic body portion 5a, second magnetic body portion 5b, and third magnetic body portion 5c. The aspect ratio of magnetic body portion 50 increases with the distance from center line CL in X axial direction DR1 of magnet portion 2.

Subsequently, operation and effect of the present embodiment is described.

According to magnetic detection device 100 according to the present embodiment, as shown in FIG. 7, first magnetic body portion 5a has a larger dimension along the longitudinal direction than second magnetic body portion 5b. Therefore, it is possible to make the effect of correcting the magnetic field by first magnetic body portion 5a stronger than the effect of correcting the magnetic field by second magnetic body portion 5b. Therefore, by properly using first magnetic body portion 5a or second magnetic body portion 5b depending on the intensity of the magnetic field applied to each of plurality of magneto-electric conversion elements 4, it is possible to adjust the sensitivity of plurality of magneto-electric conversion elements 4.

More specifically, the magnetic field applied to magneto-electric conversion element 4 arranged in an end part of substrate 3 (first magneto-electric conversion element 4a) has larger X axial direction DR1 component than the magnetic field applied to magneto-electric conversion element 4 arranged closer to the center of substrate 3 (second magneto-electric conversion element 4b). Therefore, first magneto-electric conversion element 4a is more likely to be influenced by X axial direction DR1 component of magnetic field than second magneto-electric conversion element 4b. Therefore, it is preferred that the magnetic field applied to first magneto-electric conversion element 4a is corrected more strongly than the magnetic field applied to second magneto-electric conversion element 4b. In the present embodiment, first magnetic body portion 5a having a larger aspect ratio than second magnetic body portion 5b is overlaid on first magneto-electric conversion element 4a, and second magnetic body portion 5b is overlaid on second magneto-electric conversion element 4b. Thus, it is possible to correct the magnetic field applied to first magneto-electric conversion element 4a more strongly than the magnetic field applied to second magneto-electric conversion element 4b. Therefore, it is possible to reduce the influence of X axial direction DR1 component of magnetic field for first magneto-electric conversion element 4a.

### Embodiment 4

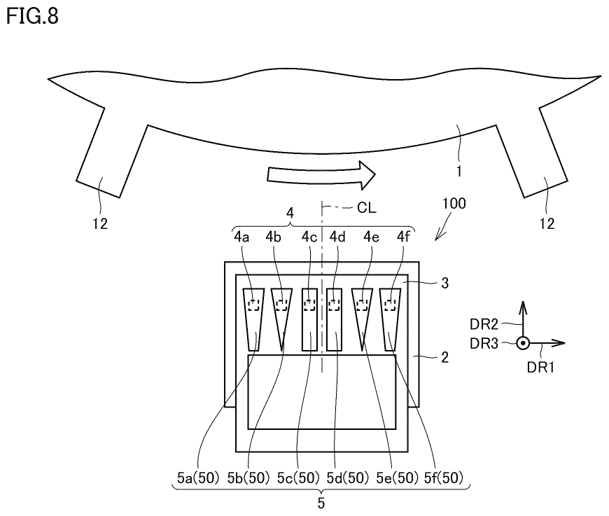

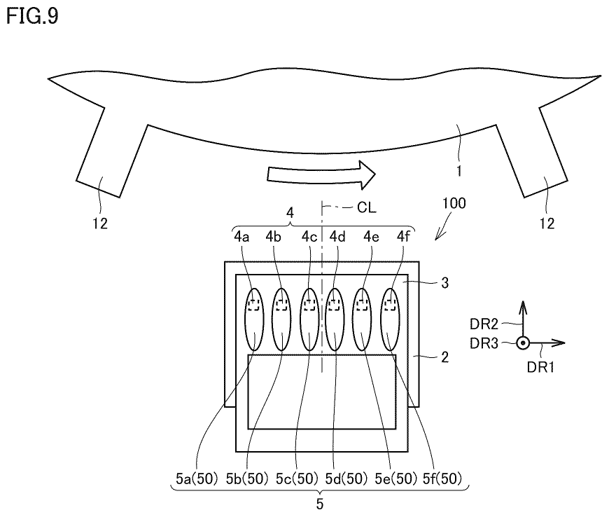

Next, referring to FIG. 8 and FIG. 9, a configuration of magnetic detection device 100 according to Embodiment 4 is described. Embodiment 4 has the same configuration and operation and effect as Embodiment 1 unless otherwise described. Therefore, the same configuration as that in Embodiment 1 is denoted by the same reference numeral, and description thereof is not repeated.

As shown in FIG. 8, the shape of magnetic plate 5 when magnetic plate 5 of magnetic detection device 100 according to the present embodiment is viewed along the magnetization direction is a polygon. The shape of magnetic body portion 50 when each of plurality of magnetic body portions 50 is viewed along the magnetization direction is a polygon. The shape of magnetic body portion 50 when each of plurality of magnetic body portions 50 is viewed along the magnetization direction is, for example, a triangle or a trapezoid. The shapes of all of plurality of magnetic body portions 50 may be triangles or may be trapezoids. The shape of each of plurality of magnetic body portions 50 may be any one of a triangle, a trapezoid and a rectangle. In the present embodiment, the shapes of first magnetic body portion 5a and second magnetic body portion 5b are trapezoids. The shapes of second magnetic body portion 5b and fifth magnetic body portion 5e are triangles. The shapes of third magnetic body portion 5c and fourth magnetic body portion 5d are rectangles.

As shown in FIG. 9, the shape of magnetic plate 5 when magnetic plate 5 of magnetic detection device 100 according to a modified example of Embodiment 4 is viewed along the magnetization direction is an oval. The shape of magnetic body portion 50 when each of plurality of magnetic body portions 50 is viewed along the magnetization direction is an oval. In the present embodiment, the longitudinal direction of magnetic plate 5 means the direction in which the major axis of oval extends, and the short direction of magnetic plate 5 means the direction in which the minor axis of oval extends.

Subsequently, operation and effect of the present embodiment is described.

According to magnetic detection device 100 according to the present embodiment, as shown in FIG. 8, the shape of magnetic plate 5 when magnetic plate 5 is viewed along the magnetization direction is a polygon. Therefore, a polygonal plate can be used as magnetic plate 5. Also, by varying the shape for each of the plurality of magnetic body portions 50, it is possible to differentiate the effect of correcting magnetic field by each of plurality of magnetic body portions 50. Thus, it is possible to individually adjust the sensitivity of each of plurality of magneto-electric conversion elements 4.

As shown in FIG. 8, the shape of magnetic plate 5 is a triangle or a trapezoid. Therefore, the effect of correcting the magnetic field by magnetic plate 5 can be made different from that when the shape of magnetic plate 5 is a rectangle.

According to magnetic detection device 100 according to a modified example of the present embodiment, as shown in FIG. 9, the shape of magnetic plate 5 when magnetic plate 5 is viewed along the magnetization direction is an oval. Therefore, an oval plate can be used as magnetic plate 5.

As shown in FIG. 9, the shape of magnetic plate 5 is an oval. Therefore, the effect of correcting the magnetic field by magnetic plate 5 can be made different from that when the shape of magnetic plate 5 is a rectangle.

### Embodiment 5

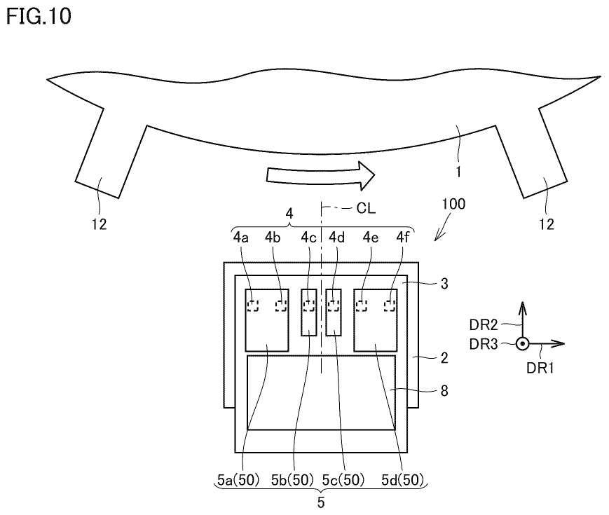

Next, referring to FIG. 10, a configuration of magnetic detection device 100 according to Embodiment 5 is described. Embodiment 5 has the same configuration and operation and effect as Embodiment 1 unless otherwise described. Therefore, the same configuration as that in Embodiment 1 is denoted by the same reference numeral, and description thereof is not repeated.

As shown in FIG. 10, in magnetic detection device 100 according to the present embodiment, magnetic plate 5 includes plurality of magnetic body portions 50. Magnetic plate 5 includes at least one magnetic body portion 50 overlaid on plurality of magneto-electric conversion elements 4 along the magnetization direction. While magnetic body portion 50 is overlaid on two magneto-electric conversion elements 4 in FIG. 10, magnetic body portion 50 may be overlaid on two or more magneto-electric conversion elements 4.

Specifically, first magnetic body portion 5a is overlaid on first magneto-electric conversion element 4a and second magneto-electric conversion element 4b along the magnetization direction. Second magnetic body portion 5b is overlaid on third magneto-electric conversion element 4c along the magnetization direction. Third magnetic body portion 5c is overlaid on fourth magneto-electric conversion element 4d along the magnetization direction. Fourth magnetic body portion 5d is overlaid on fifth magneto-electric conversion element 4e and sixth magneto-electric conversion element 4f along the magnetization direction. First magnetic body portion 5a and fourth magnetic body portion 5d have larger dimensions in X axial direction DR1 and dimensions in Y axial direction DR2 than second magnetic body portion 5b and third magnetic body portion 5c.

Subsequently, operation and effect of the present embodiment is described.

According to magnetic detection device 100 according to the present embodiment, as shown in FIG. 10, magnetic plate 5 includes at least one magnetic body portion 50 overlaid on plurality of magneto-electric conversion elements 4 along the magnetization direction. Therefore, it is possible to reduce the number of plurality of magnetic body portions 50 compared with the case where each of plurality of magnetic body portions 50 is overlaid on each of plurality of magneto-electric conversion elements 4. Therefore, it is possible to reduce the number of parts of magnetic detection device 100. Therefore, it is possible to facilitate assembling of magnetic detection device 100.

### Embodiment 6

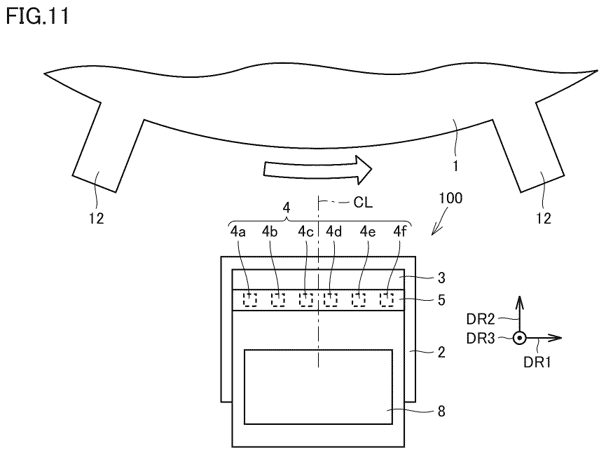

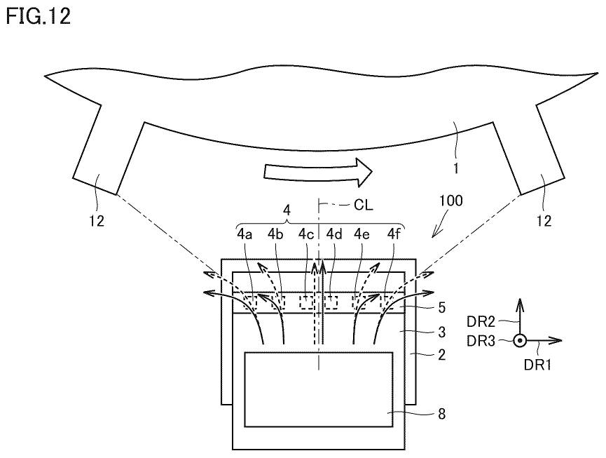

Next, referring to FIG. 11 and FIG. 12, a configuration of magnetic detection device 100 according to Embodiment 6 is described. Embodiment 6 has the same configuration and operation and effect as Embodiment 1 unless otherwise described. Therefore, the same configuration as that in Embodiment 1 is denoted by the same reference numeral, and description thereof is not repeated.

As shown in FIG. 11, magnetic plate 5 of magnetic detection device 100 according to the present embodiment is overlaid on all of magneto-electric conversion elements 4. In the present embodiment, magnetic plate 5 is overlaid on all of first magneto-electric conversion element 4a to sixth magneto-electric conversion element 4f.

In the present embodiment, the magnetism sensing direction of plurality of magneto-electric conversion elements 4 runs along the direction in which plurality of magneto-electric conversion elements 4 are arranged (X axial direction DR1). The direction in which plurality of magneto-electric conversion elements 4 are arranged runs along the moving direction of moving magnetic body 1.

In the present embodiment, the longitudinal direction of magnetic plate 5 runs along the moving direction of moving magnetic body 1. The longitudinal direction of magnetic plate 5 runs along the direction in which plurality of magneto-electric conversion elements 4 are arranged. The longitudinal direction of magnetic plate 5 runs along X axial direction DR1. The short direction of magnetic plate 5 runs along Y axial direction DR2.

Next, the operation and effect of the present embodiment is described by comparison with magnetic detection device 101 according to the comparative example shown in FIG. 5.

As shown in FIG. 5, in magnetic detection device 101 according to the comparative example, when protruding portion 12 is arranged at a position apart from first magneto-electric conversion element 4a, there is an angular difference between the direction of the magnetic field applied to first magneto-electric conversion element 4a and the direction of the line connecting first magneto-electric conversion element 4a and protruding portion 12. The angular difference is smaller than the angular difference in the case where magnetic plate 5 is provided (see FIG. 11). The magnetic field changes to be drawn in by approach of protruding portion 12. However, since the angular difference is smaller than that in the case where magnetic plate 5 is provided (see FIG. 11), change in the magnetic field applied to first magneto-electric conversion element 4a when protruding portion 12 moves to approach first magneto-electric conversion element 4a is also smaller than that in the case where magnetic plate 5 is provided (see FIG. 11). Therefore, change in X axial direction DR1 component of the magnetic field applied to magneto-electric conversion element 4 is also smaller than that in the case where magnetic plate 5 is provided (see FIG. 11). Therefore, also change in the magnetic field sensed by magneto-electric conversion element 4 is smaller than that in the case where magnetic plate 5 is provided (see FIG. 11). Therefore, the detection sensitivity of magnetic detection device 101 according to the comparative example is lower than that in the case where magnetic plate 5 is provided (see FIG. 11).

Also, sensitivity of magneto-electric conversion element 4 can deteriorate when a magnetic field of the direction (Y axial direction DR2) orthogonal to the magnetism sensing direction (X axial direction DR1) is applied. In particular, in magnetic detection device 101 according to the comparative example, Y axial direction DR2 component of the magnetic field in magneto-electric conversion elements 4 arranged in end parts of substrate 3 (first magneto-electric conversion element 4a and sixth magneto-electric conversion element 4f) is larger than that in magneto-electric conversion elements 4 arranged in the center of substrate 3. Therefore, the detection sensitivity of magneto-electric conversion elements 4 arranged in end parts of substrate 3 is lower than that of magneto-electric conversion elements arranged in the center of substrate 3.

In contrast to this, according to magnetic detection device 100 according to the present embodiment, as shown in FIG. 12, the magnetism sensing direction of plurality of magneto-electric conversion elements 4 runs along the direction in which plurality of magneto-electric conversion elements 4 are arranged (X axial direction DR1). The longitudinal direction of magnetic plate 5 runs along the direction in which plurality of magneto-electric conversion elements 4 are arranged (X axial direction DR1). Therefore, it is possible to correct the magnetic field so that the magnetic field applied to each of plurality of magneto-electric conversion elements 4 runs along the direction in which plurality of magneto-electric conversion elements 4 are arranged (X axial direction DR1). Also, it is possible to reduce Y axial direction DR2 component of the magnetic field. Therefore, it is possible to increase change in the magnetic field when the magnetic moving body approaches magneto-electric conversion element 4 compared with the case where magnetic plate 5 is not provided (see FIG. 5). Therefore, it is possible to improve the detection sensitivity of magnetic detection device 100.

More specifically, the longitudinal direction of magnetic plate 5 runs along the direction in which plurality of magneto-electric conversion elements 4 are arranged (X axial direction DR1). Therefore, it is possible to correct the magnetic field generated from magnet portion 2 to run along the longitudinal direction of magnetic plate 5. Since the longitudinal direction of magnetic plate 5 runs along X axial direction DR1, the magnetic field generated from magnet portion 2 can be corrected to run along X axial direction DR1. That is, the magnetic field component of Y axial direction DR2 of the magnetic field reduces. Thus, it is possible to increase the angular difference between the direction of the magnetic field applied to first magneto-electric conversion element 4a and the direction connecting first magneto-electric conversion element 4a and protruding portion 12 when protruding portion 12 is arranged at a position apart from first magneto-electric conversion element 4a. Therefore, it is possible to increase change in angle of the magnetic field applied to first magneto-electric conversion element 4a when protruding portion 12 moves to approach first magneto-electric conversion element 4a. Therefore, it is also possible to increase change in the magnetic field sensed by magneto-electric conversion element 4. Therefore, it is possible to improve the detection sensitivity of magnetic detection device 100.

According to magnetic detection device 100 according to the present embodiment, magnetic plate 5 is overlaid on all of magneto-electric conversion elements 4. Therefore, it is possible to reduce the number of parts of magnetic detection device 100 compared with the case where magnetic plate 5 is not overlaid on all of magneto-electric conversion elements 4.

### Embodiment 7

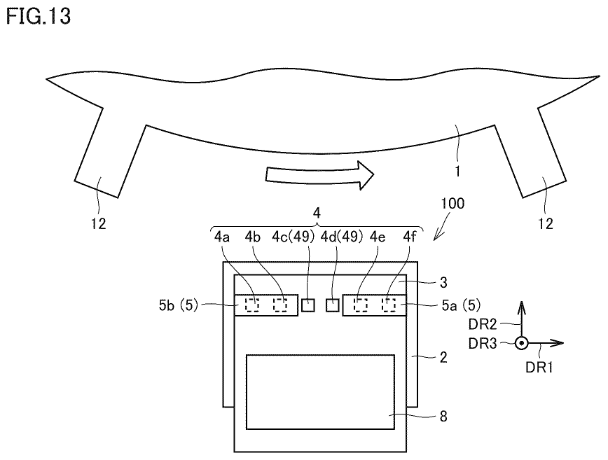

Next, referring to FIG. 13, a configuration of magnetic detection device 100 according to Embodiment 7 is described. Embodiment 7 has the same configuration and operation and effect as Embodiment 6 unless otherwise described. Therefore, the same configuration as that in Embodiment 6 is denoted by the same reference numeral, and description thereof is not repeated.

Plurality of magneto-electric conversion elements 4 of magnetic detection device 100 according to the present embodiment have at least one exposed element 49. Exposed element 49 is exposed from magnetic plate 5 along the magnetism sensing direction. That is, magnetic plate 5 is not overlaid on exposed element 49.

Specifically, magnetic plate 5 is overlaid on first magneto-electric conversion element 4a, second magneto-electric conversion element 4b, fifth magneto-electric conversion element 4e and sixth magneto-electric conversion element 4f. Third magneto-electric conversion element 4c and fourth magneto-electric conversion element 4d are exposed elements 49.

Subsequently, operation and effect of the present embodiment is described.

According to magnetic detection device 100 according to the present embodiment, as shown in FIG. 13, exposed element 49 is exposed from magnetic plate 5 along the magnetism sensing direction. Therefore, the magnetic field applied to exposed element 49 is not corrected by magnetic plate 5. Therefore, in the condition that the magnetic field applied to exposed element 49 is directed to Y axial direction DR2, the magnetic field applied to other magneto-electric conversion element 4 can be directed to X axial direction DR1. That is, it is possible to adjust the direction of the magnetic field applied to each of plurality of magneto-electric conversion elements 4. Therefore, it is possible to individually adjust the sensitivity of each of plurality of magneto-electric conversion elements 4.

It is to be understood that the embodiments disclosed herein are illustrative, but are not restrictive in every respect. The scope of the present disclosure is indicated by the appended claims rather than by the description described above, and it is intended that all modifications within the equivalent meaning and scope of the claims are included.

### REFERENCE SIGNS LIST

2: magnet portion, 4: magneto-electric conversion element, 5: magnetic plate, 5a: first magnetic body portion, 5b: second magnetic body portion, 50: magnetic body portion, 51: first magnetic body part, 52: second magnetic body part, 100: magnetic detection device

1. A magnetic detection device to detect a moving magnetic body that is rotating, the magnetic detection device comprising:
a magnet portion;
a plurality of magneto-electric conversion elements overlaid on the magnet portion along a magnetization direction of the magnet portion; and
a magnetic plate overlaid on the plurality of magneto-electric conversion elements along the magnetization direction,
a magnetism sensing direction of the plurality of magneto-electric conversion elements intersecting with the magnetization direction,
the magnetization direction of the magnet portion being in parallel with a rotation axis of the moving magnetic body, and
the magnetic plate having a longitudinal direction that intersects with the magnetization direction and runs along a direction toward the rotation axis of the moving magnetic body.

2. The magnetic detection device according to claim 1, wherein the longitudinal direction of the magnetic plate runs along the magnetism sensing direction of the plurality of magneto-electric conversion elements.

3. The magnetic detection device according to claim 1, wherein
the magnetic plate includes a plurality of magnetic body portions, and
each of the plurality of magnetic body portions is overlaid on a corresponding one of the plurality of magneto-electric conversion elements.

4. The magnetic detection device according to claim 3, wherein
the magnetic plate has a short direction that is orthogonal to the longitudinal direction,
each of the plurality of magnetic body portions is divided into a first magnetic body part and a second magnetic body part along the short direction, and
on each of the plurality of magneto-electric conversion elements, the first magnetic body part and the second magnetic body part are overlaid.

5. The magnetic detection device according to claim 3, wherein
the plurality of magnetic body portions include a first magnetic body portion and a second magnetic body portion, and
the first magnetic body portion has a larger dimension along the longitudinal direction than the second magnetic body portion.

6. The magnetic detection device according to claim 1, wherein a shape of the magnetic plate when the magnetic plate is viewed along the magnetization direction is a polygon.

7. The magnetic detection device according to claim 1, wherein the shape of the magnetic plate when the magnetic plate is viewed along the magnetization direction is a rectangle.

8. The magnetic detection device according to claim 1, wherein the shape of the magnetic plate when the magnetic plate is viewed along the magnetization direction is an oval.

9. The magnetic detection device according to claim 1, wherein the magnetic plate is overlaid on all of the plurality of magneto-electric conversion elements.

10. (canceled)

11. The magnetic detection device according to claim 1, wherein each of the plurality of magneto-electric conversion elements is an MR element or an MI element.

12. The magnetic detection device according to claim 11, wherein each of the plurality of magneto-electric conversion elements is either of a GMR element and a TMR element.

13. A magnetic detection device to detect a moving magnetic body that is rotating, the magnetic detection device comprising:
a magnet portion;
a plurality of magneto-electric conversion elements overlaid on the magnet portion along a magnetization direction of the magnet portion; and
a magnetic plate overlaid on the plurality of magneto-electric conversion elements along the magnetization direction,
a magnetism sensing direction of the plurality of magneto-electric conversion elements intersecting with the magnetization direction,
the magnetization direction of the magnet portion being in parallel with a rotation axis of the moving magnetic body,
the magnetism sensing direction of the plurality of magneto-electric conversion elements running along a direction in which the plurality of magneto-electric conversion elements are arranged, and
the magnetic plate having a longitudinal direction that intersects with the magnetization direction and runs along the direction in which the plurality of magneto-electric conversion elements are arranged.

14. The magnetic detection device according to claim 13, wherein the shape of the magnetic plate when the magnetic plate is viewed along the magnetization direction is a rectangle.
